(19) United States
(12) Patent Application Publication
(10) Pub. No.: US 2016/0290618 A1
(43) Pub. Date: Oct. 6, 2016

(54) ILLUMINATING UNIT WITH TWO MODULES

(71) Applicant: OSRAM Opto Semiconductors GmbH, Regensburg (DE)

(72) Inventor: Christopher Eichelberger, Livonia, MI (US)

(21) Appl. No.: 14/674,065

(22) Filed: Mar. 31, 2015

(51) Int. Cl. F21V 23/06; F21V 15/01

(52) U.S. Cl. CPC F21V 23/06; F21V 15/01

(57) ABSTRACT

An illuminating unit includes at least two modules, wherein each module includes a housing and a light-emitting device that is fixed to the housing, each housing includes beam forming optics, each housing includes four side walls, the first side wall includes a first mechanical connector, the second side wall includes a second mechanical connector, the first mechanical connector of the first module connects with the second mechanical connector of the second module, and the first side wall and the second side wall of the housings of the first and second module have the same shape.

### TECHNICAL FIELD

This disclosure refers to an illuminating unit.

### BACKGROUND

US 2012/0020104 A1 discloses an automotive headlamp and a fog lamp using light-emitting diodes.

### SUMMARY

We provide an illuminating unit based on modules with housings that can be used to produce different designs of different illuminating units. Therefore, a high flexibility in producing different designs of illuminating units is attained. Especially different types of automotive headlamps or fog lamps can be produced. Furthermore, we provide a method of producing an illuminating unit with modules.

We provide an illuminating unit that comprises at least two modules, wherein each module comprises a housing with first and second mechanical connecting means that can be used to connect the two modules. The first side wall and the second side wall of the housing of the first module and the first side wall and the second side wall of the housing of the second module have the same shape. Since the first and second side wall of the housings of the modules have the same shape different designs of illuminating units can be produced by using these housings.

### BRIEF DESCRIPTION OF THE DRAWINGS

Different examples of the illuminating units are described with a reference to the following figures.

FIG. 1 shows a first example of a module.

FIG. 2 depicts a second view of the module of FIG. 1.

FIG. 3 depicts a mounting process of two modules.

FIG. 4 depicts a schematic side view of a module.

FIG. 5 depicts a schematic top view of the module of FIG. 4.

FIG. 6 depicts a schematic view of a further module.

FIG. 7 depicts a schematic view of a further example of a module.

FIG. 8 depicts a schematic view of an illuminating unit with four modules.

FIG. 9 depicts a further example of an illuminating unit with three modules.

FIG. 10 depicts a schematic view of a further illuminating unit with two modules.

FIG. 11 depicts a further example of an illuminating unit.

### REFERENCE SIGNS

1 first module

2 housing

3 opening

4 light-emitting device

5 optics

6 first side wall

7 second side wall

8 third side wall

9 fourth side wall

10 emitting face

11 first connecting means

12 second connecting means

13 second module

14 printed circuit board

15 third connecting means

16 fourth connecting means

17 illuminating unit

18 third module

19 fourth module

20 frame

### DETAILED DESCRIPTION

It will be appreciated that the following description is intended to refer to specific examples of structure selected for illustration in the drawings and is not intended to define or limit the disclosure, other than in the appended claims.

We provide an illuminating unit produced by using building blocks. The building blocks are represented by modules, wherein each module comprises a housing and a light-emitting device fixed to the housing, wherein each housing comprises beam forming optics, each housing comprises four side walls, the first side wall comprises first mechanical connecting means, wherein the second side wall comprises second mechanical connecting means, the first mechanical connecting means of the first module connects with the second mechanical connecting means of the second module, and the first side wall and the second side wall of the housings of the first and the second module have the same shape and the first mechanical connection means correspond to the second mechanical connection means. The first and the second side wall may have plane faces with the same size and the same design. Furthermore, the first and the second side wall may be identical despite the first and second mechanical connecting means. The first and the second mechanical connecting means may be embodied as corresponding form fit and/or press fit connecting means. The first and second side wall may be arranged at opposite sides of the housing.

These building blocks can be used to stick at least two or more building blocks together to form an illuminating unit. The modules may differ referring to the light-emitting device and/or referring to the beam forming optics.

We provide housings with a third wall and a fourth side wall, wherein the third side wall and the fourth side wall of the housings of the first and the second module have the same shape. The third and the fourth side wall may have plane faces with the same size and the same design. Furthermore, the third and the fourth side wall may be identical despite the third and the fourth mechanical connecting means. The third and the third mechanical connecting means may be embodied as corresponding form fit and/or press fit connecting means. The third and fourth side wall may be arranged at opposite sides of the housing. Therefore, different shapes of illuminating units can be fabricated with the proposed housings.

We provide a module with a housing that comprises first mechanical means in the shape of at least one pin and the second mechanical means are in the shape of at least one hole. These simple mechanical means provide a form fit and/or a press fit connection between two modules.

We provide first and second mechanical means arranged at opposite side walls of the housing. This is a basic design that allows different designs of illuminating units with different length.

We provide a module with a housing that comprises at a third side wall third mechanical connecting means and at a fourth side wall fourth mechanical connecting means, wherein the third mechanical connecting means and the fourth mechanical connecting means provide a form fit and/or a press fit connection. This example may provide a higher flexibility to combine one module at four side walls with a second module that comprise at least a similar housing or an identical housing. This allows the production of different shapes of illuminating units in a two dimensional plane.

We provide an illuminating unit with at least two modules, wherein the housings of the modules are identical.

We provide an illuminating unit that comprises three or more modules. This allows the production of an illuminating unit with a large light emitting face.

We provide an illuminating unit that comprises three modules designed with the same shape especially referring to the connecting means.

We provide an illuminating unit that comprises at least two modules, wherein each module comprises a housing, and the housings have an identical shape. Therefore, the illuminating units can easily be produced based on the same housings.

We provide a module with a housing made of plastics. Plastics can easily be processed and formed.

We provide a first and a second module with a housing that are designed identically. Therefore, it is possible to use one type of module and to combine this type of module illuminating units with different shapes.

We provide a module with a housing wherein the side walls of the housing are arranged in that way that two pairs of side walls are provided, wherein the side walls of one pair are arranged in parallel and the side walls of the second pair are also arranged in parallel. The side walls of the first pair may be arranged perpendicular to the side walls of the second pair.

We provide a housing partially made of intransparent plastics. Furthermore, a front part of the housing may be made of optical grade plastics. The housing may be made by a two-shot-process. The proposed housing can easily be produced, wherein the optical grade plastics may be a lens that guides a light beam in a predetermined direction.

We provide an illuminating unit with at least two modules, wherein a robustness of the unit is increased by a frame that circumvents the two modules.

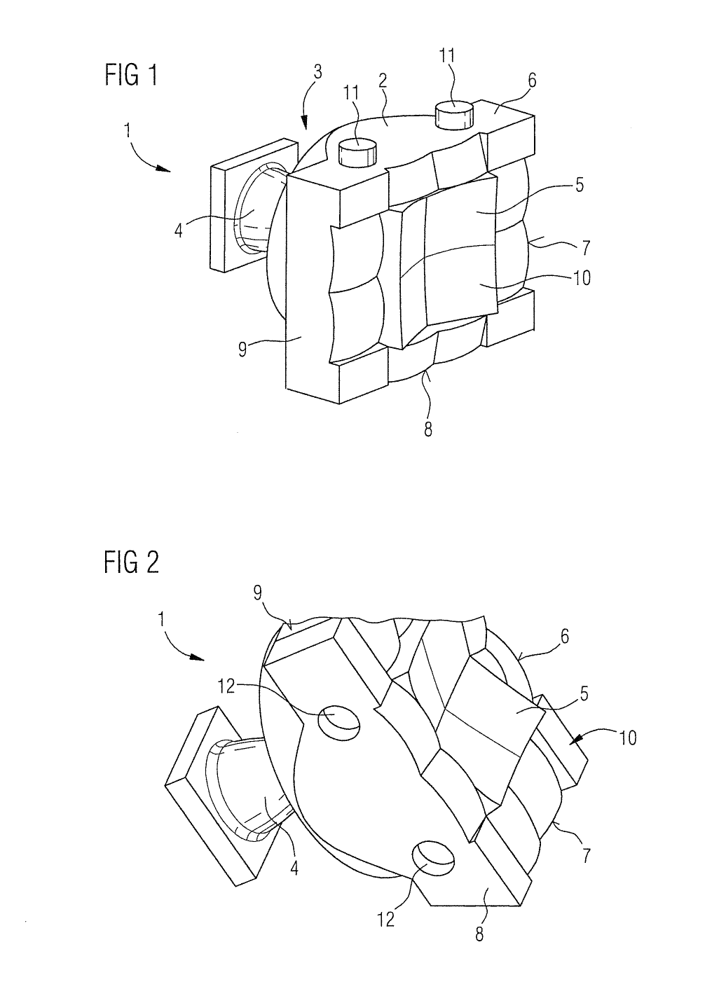

FIG. 1 depicts a first module 1, wherein the first module 1 comprises a housing 2 with an opening 3 at a backside that receives a light-emitting device 4. The housing 2 comprises at a front side beam forming optics 5. The housing 2 comprises four sidewalls 6, 7, 8, 9. The first and the third side walls 6, 8 are arranged at opposite sides of a light-emitting face 10. The first and the third side walls 6, 8 are arranged in this example in parallel. The second and the fourth side walls 7, 9 are also arranged in parallel and at opposite sides of the light-emitting face 10. The first and the second side walls 6, 7 are arranged perpendicular to each other. The light emitting face 10 is arranged at the front side of the housing 2. This means that emitting face 10 at which the optics 5 is arranged, has the shape of a rectangle and, for example, the shape of a square. The side walls 6, 7, 8, 9 are plane faces. The second and the third side wall 7, 9 comprise connecting means. The first connecting means 11 of the first side wall 6 are, for example, two pins. The two pins protect from the plain face of the first side wall 6 in a vertical direction.

FIG. 2 depicts the first module 1 of FIG. 1 from a bottom view. Second connecting means 12 arranged at the third side wall 8 are in this example as recesses. The first and the second connecting means 11, 12 are mechanical means that allow a mechanical connection to each other. This means that the first connecting means 11 of one module and the second connecting means 12 of another module allow a form fit connection and/or a press fit connection between the two modules.

In the example, the recesses 12 correspond to the pins 11 which means that the pins 11 can be pushed in corresponding recesses 12 providing a form fit and/or a press fit connection. Depending on the example, the first and/or the second connecting means may have different shapes, for example, different shapes of pins and/or different shapes of holes that may provide first and second mechanical connecting means 11, 12.

Furthermore, depending on the example, also one side wall, for example, the first side wall 6 may comprise one first connecting means 11 and one second connecting means 12. Furthermore, the third side wall 8 may also comprise one first connecting means 11 and one second connecting means 12. In this example, the first and the second connecting means 11, 12 are arranged at opposite sides at the first and the third side wall 6, 8. The housing 2 defines a block with four edges that are defined by the four side walls 6, 8, 7, 9.

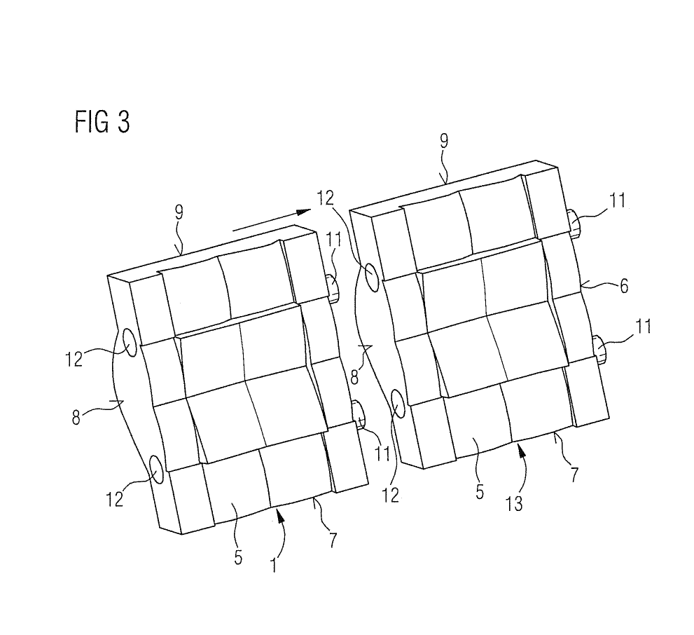

FIG. 3 depicts a first module 1 and a second module 13 during an assembling process whereby the first connecting means 11 of the first module 1 are pushed in the second connecting means 12 of the second module 13. In the example, the first and the second module 1, 13 have the same housing size. Furthermore, the housing of the first and the second module 1, 13 comprise the same first and second connecting means 11, 12. Depending on the example, the housing of the first and the second module 1, 13 may be identical. Depending on the example, the first and the second module 1, 13 may have different light-emitting devices for and/or different optics 5. The size of the housing 2 of the first and the second module 1, 13 may be identical. In a further example, the first and the second module 1, 13 may be identical.

Depending on the example, the housing 2 may be formed by nontransparent material. As material, for example, plastics may be used. Furthermore, the optics 5 may be formed by transparent material, for example, transparent glass or transparent plastics. The optics 5 may be formed as a lens defining a specific beam pattern, especially a beam pattern with sharp cut-off rims. A sharp cut-off rims of the beam pattern is an advantage for a headlamp or a fog lamp of a car. In a further example, the housing 2 and the optics 5 may be formed by a two shot process using plastics. With the two shot process the intransparent plastics for the housing and the transparent plastics for the optics 5 can be easily formed.

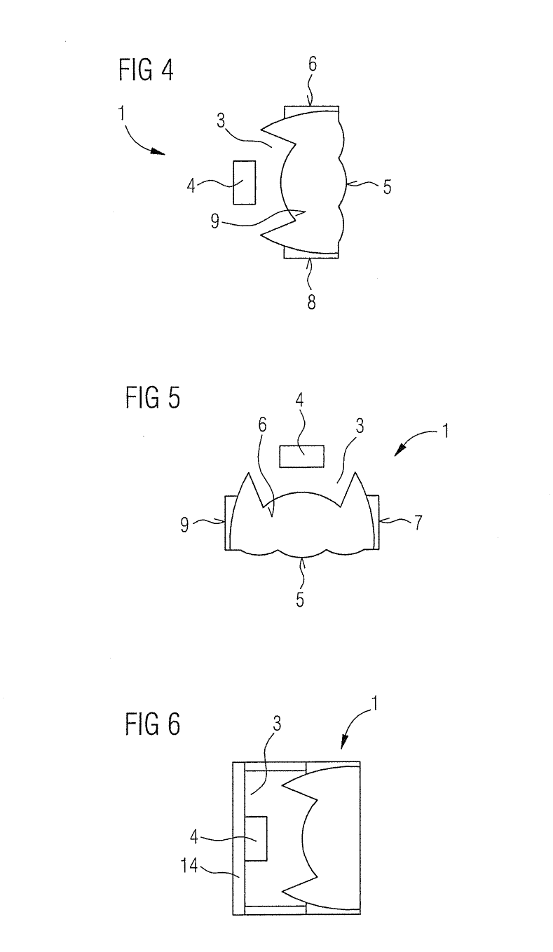

FIG. 4 depicts a schematic side view of the first module 1 with the light-emitting device 4. In this view, the first and second connecting means are not depicted. The plane faces of the first and third side wall 6, 8 can be seen.

FIG. 5 depicts a top view of the first module 1 of FIG. 4. The plane faces of the second and fourth side wall can be seen. The light-emitting device 4 may be a light-emitting diode or a laser diode. In this view, the first and second connecting means are not depicted.

FIG. 6 depicts a cross sectional view of the first module 1, wherein the light-emitting device 4 is mounted on a printed circuit board 14. The printed circuit board 14 is fixed at a backside of the housing 2 enclosing the opening 3. At a front side of the housing 2, the optics 5 is mechanically fixed to the housing 2. Depending on the example, the same type of housing 2 may comprise different light emitting devices 4 and/or different types of optics 5. In this view, the first and second connecting means are not depicted.

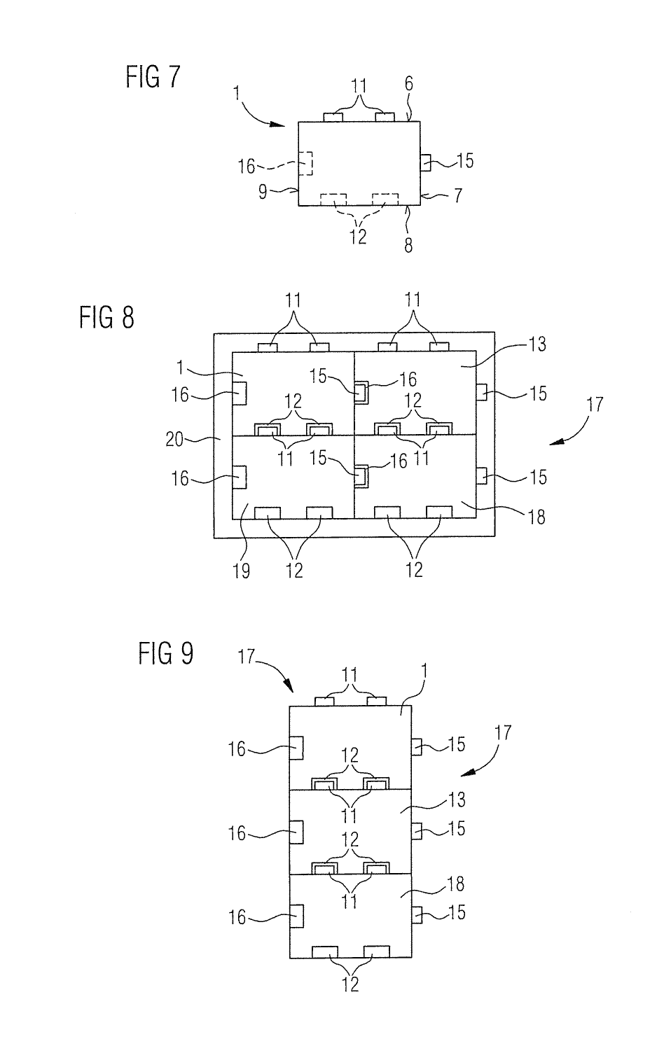

FIG. 7 depicts a further example of the first module 1 that comprises third connecting means 15 at second side wall 7. Furthermore, the first module 1 comprises fourth connecting means 16 at the fourth side wall 9. In the example, the third connecting means 15 are a pin or a knop or a stand-off that project vertically from the plane second side wall 7. The fourth connecting means 16 of the fourth side wall 9 is a recess that corresponds to the third connecting means 15. The fourth connecting 16 and the second connecting means 12 are depicted with dotted lines. The third and fourth connecting means 15, 16 are formed in that way that a press fit and/or a form fit connection may be attained by connecting a third connecting means 15 of a first module 1 with a fourth connecting means 16 of a further first module 1. This type of first module 1 allows to combine several first modules 1 not only in one direction as shown in FIG. 3, but also in two directions. Depending on the example, the pins, knops or stand-offs and/or the openings may be molded in plastics with respective type tolerances to allow a press fit and/or a form fit connection.

FIG. 8 detect a schematic view of an illuminating unit 17 with four modules 1, 13, 18, 19. The modules connect using first, second, third and fourth connecting means 11,12,15,16. The first, the second, the third and the fourth module 1, 13, 18, 19 comprise at least the same housing 2 with the same first, second, third, fourth connecting means 11, 12, 15, 16. The modules are assembled together using the connecting means to provide an illuminating unit 17 with a predetermined beam pattern. Due to the good mechanical alignment a good optical alignment is attained. The good mechanical alignment is attained by the plane side walls 6, 7, 8, 9 and the used connecting means 11, 12, 15, 16.

Depending on the example, the modules 1, 13, 18, 19 are additionally fixed together by glue that is disposed on the side walls 6,7,8,9 between the modules 1,13,18,19. In a further example, additionally or instead to the glue a frame 20 may be used to increase the mechanical connection between the modules. The frame 20 circumvents the modules 1,13,18,19 of the illuminating unit 17. The frame 20 may be, for example, made of plastics or metal. The first, second, third, fourth connecting means 11, 12, 15, 16 are depicted schematically although they are not visible at the illuminating unit 17 of FIG. 8.

FIG. 9 depicts a third example with three modules 1, 13, 18 arranged in one line. Depending on the example, there may also be used a glue to connect the modules and/or a frame to increase the mechanical connection between the modules. Depending on the example, the housing 2 with the first, second, third and fourth connecting means may be identical. However, depending on the example, the light-emitting devices 4 of the modules and/or the optics 5 of the modules may be different. This allows to provide a different specific beam patterns using the same housing 2.

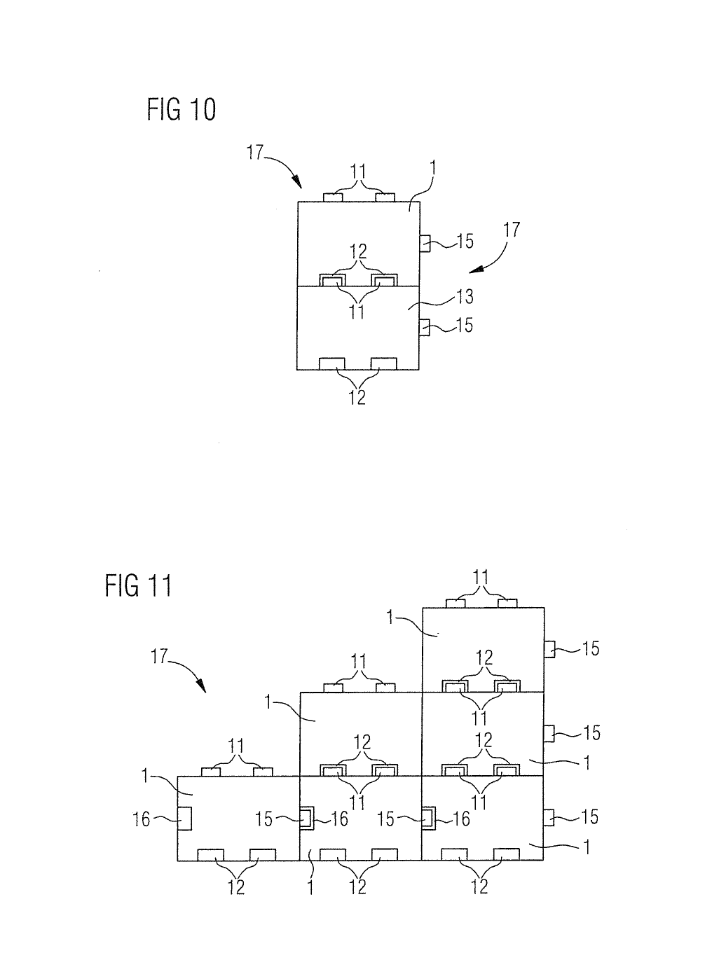

FIG. 10 depicts a further example of an illuminating unit 17 with a first and a second module 1, 13.

FIG. 11 depicts a schematic view of a further example of an illuminating unit 17 with six modules 1 arranged with a specific shape. Also in this example, the modules connect via the first, second, third and fourth connecting means. Furthermore, depending on the example, there may also be glue layers that connect the modules and/or a frame that circumvents the modules of the illuminating units 17.

Although the apparatus and methods have been described in connection with specific forms thereof, it will be appreciated that a wide variety of equivalents may be substituted for the specified elements described herein without departing from the spirit and scope of this disclosure as described in the appended claims.

1. An illuminating unit comprising:
at least two modules, wherein each module comprises a housing and a light-emitting device that is fixed to the housing, each housing comprises beam forming optics, each housing comprises four side walls, the first side wall comprises a first mechanical connector, the second side wall comprises a second mechanical connector, the first mechanical connector of the first module connects with the second mechanical connector of the second module, and the first side wall and the second side wall of the housings of the first and the second module have the same shape.

2. The unit according to claim 1, wherein the third and the fourth side wall of the housings of the first module and of the second module have the same shape.

3. The unit according to claim 1, wherein the first mechanical means are in the shape of at least one pin and the second mechanical means are in the shape of at least one hole, and the hole and the pin provide a form fit connection and/or a press fit connection.

4. The unit according to claim 1, wherein the first mechanical means are in the shape of at least one pin and the second mechanical means are in the shape of at least one hole, the hole and the pin provide a form fit connection and/or a press fit connection, the first mechanical means are in the shape of at least two pins and the second mechanical means are in the shape of at least two holes, and the holes and the pins are designed to provide a form fit connection and/or a press fit connection.

5. The unit according to claim 1, wherein the first and the second mechanical means are arranged at opposite side walls of the housing.

6. The unit according to claim 1, wherein the housings comprise at a third side wall and at a fourth side wall third mechanical connector and fourth mechanical connector, and the third mechanical connector and the fourth mechanical connector provide a form fit connection or a press fit connection.

7. The unit according to claim 1, wherein the housings comprise at a third side wall and at a fourth side wall third mechanical connector and fourth mechanical connector, the third mechanical connector and the fourth mechanical connector provide a form fit connection or a press fit connection, a third housing is arranged, the third housing is the first housing, and the third mechanical connector of the third housing is fixed to the fourth mechanical connector of the first housing.

8. The unit according to claim 1, wherein the housings comprise at a third side wall and at a fourth side wall third mechanical connector and fourth mechanical connector, the third mechanical connector and the fourth mechanical connector provide a form fit connection or a press fit connection, the third mechanical connector is at least one pin, the fourth mechanical connector is at least at least one hole, and the hole and the pin provide a form fit connection or a press fit connection.

9. The unit according to claim 1, wherein the housings comprise at a third side wall and at a fourth side wall third mechanical connector and fourth mechanical connector, the third mechanical and the fourth mechanical connector provide a form fit connection or a press fit connection, a third housing is arranged, the third housing is embodied as the first housing, the third mechanical connector of the third housing is fixed to the fourth mechanical connector of the first housing, the third mechanical connector is at least one pin, the fourth mechanical connector is at least at least one hole, and the hole and the pin provide a form fit connection or a press fit connection.

10. The unit according to claim 1, wherein the housings are made of plastics.

11. The unit according to claim 1, wherein the first and second housing are designed identically.

12. The unit according to claim 1, wherein the first and the second side wall are arranged in parallel.

13. The unit according to claim 1, wherein the housings comprise at a third side wall and at a fourth side wall third mechanical connector and fourth mechanical connector, the third mechanical connector and the fourth mechanical connector provide a form fit connection or a press fit connection, and the third and fourth side wall are arranged in parallel.

14. The unit according to claim 1, wherein the housing is a partially made of intransparent plastics, a part is made of optical grade plastics, and the housing is made by a two shot process.

15. The unit according to claim 1, wherein at least two housings are encased by a frame that circumvents the at least two modules.

16. The unit according to claim 1, wherein the light-emitting device is mechanically fixed to the module.

17. A method of producing an illuminating unit with at least two modules, wherein each module comprises a housing and a light-emitting device, each housing comprises beam forming optics, each housing comprises four side walls, the first side wall comprises a first mechanical connector, the second side wall comprises a second mechanical connector, the first side wall and the second side wall of the housings of the first and second module have the same shape, the method comprising: fixing the light-emitting devices to the housings; and fixing the first mechanical connector of the first module to the second mechanical connector of the second module such that the two fixed modules define the illuminating unit.

18. The method of claim 17, wherein the four side walls of the housings of the first module and of the second module have the same shape.

19. The method of claim 17, wherein the first mechanical means are in the shape of at least one pin and the second mechanical means are in the shape of at least one hole, and the hole and the pin provide a form fit connection and/or a press fit connection.

20. The method of claim 17, wherein the first mechanical means are in the shape of at least one pin and the second mechanical means are in the shape of at least one hole, the hole and the pin provide a form fit connection and/or a press fit connection, the first mechanical means are in the shape of at least two pins and the second mechanical means are in the shape of at least two holes, and the holes and the pins are designed to provide a form fit connection and/or a press fit connection.
